(19) United States
(12) Patent Application Publication
(10) Pub. No.: US 2010/0288795 A1
(43) Pub. Date: Nov. 18, 2010

(54) SILICON DIOXIDE DISPERSION

(75) Inventors: Wolfgang Lortz, Waechtersbach (DE); Jochen Scheffler, Alzenau (DE); Gabriele Perlet, Grosskrotzenburg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/863,096

(22) PCT Filed: Dec. 30, 2008
(86) PCT No.: PCT/EP2008/068344

§ 371 Date: Jul. 15, 2010

(30) Foreign Application Priority Data
Jan. 31, 2008 (DE) 102008006883.7

(51) Int. Cl. A01N 25/04; A01N 25/06; A01P 7/02; A01P 7/04; B65D 83/14

(52) U.S. Cl. 222/394; 514/770

(57) ABSTRACT

Dispersion comprising hydrophobic pyrogenically prepared silicon dioxide, alcohol and at least one additive which promotes the dispersion and, as additional component, at least one insecticide and/or acaricide. The dispersion can be canned in spray cans and used as insecticide.

The invention relates to a silicon dioxide dispersion, to a process for the preparation thereof and to the use thereof.

Pulverulent hydrophobic silica is used to combat sucking insects, the application taking place by means of dusting (DE 38 35 592).

Disadvantageously, dust development is such that this method of insect control finds little acceptance.

The aqueous dispersions likewise described in DE 38 35 592, which consist of a hydrophobic silica and water, do not exhibit satisfactory stability.

U.S. Pat. No. 5,830,512 describes a dispersion in which satisfactory stability is achieved by addition of hydrophilic substances, such as, for example, silicas. However, the active hydrophobic component is through this diluted by a hydrophilic substance. Furthermore, only a very low stability of the dispersion, from hours to a few days, is achieved.

EP 1 250 048 describes stabilizing the dispersion of hydrophobic silicon dioxide through gelling additives, such as, for example, xanthan gum, sodium alginates or neutralized carboxyvinyl polymers, mixtures of these additives also being possible.

These gelling additives bring about, by interaction with the hydrophobic SiO₂ particles and the incorporated air, a marked structural viscosity which is exhibited when applying by spraying. Thus, during the spraying process, the viscosity of the dispersion is relatively low at the shear forces acting on it. After the dispersion drops impact the surface to be coated, the viscosity again increases strongly, in order to avoid dripping/running off from in particular vertical surfaces.

According to EP 1 250 048, in addition to the hydrophobic SiO₂ particles to be dispersed, large amounts of air are incorporated. With the known dispersion processes, this cannot be avoided without the use of wetting surfactants and antifoaming agents. Thus, in Example 1, a density of only 0.6 g/ml is specified, which means that approximately 40% of the volume consists of air.

In order to achieve a satisfactory activity, a minimum weight has to be applied to the surfaces to be sprayed. If, per spraying operation, only approximately 60% of the volume of the spraying appliances can be used, this represents a significant reduction in the effectiveness.

Disadvantageously, the transportation, packaging and waste disposal costs of the required packaging are higher by this proportion.

In addition, during storage, an approximately 40% larger storage space has to be taken into account.

Furthermore, with an air-comprising dispersion, it is not possible to achieve a homogeneous bubble-free coverage of surfaces to be treated.

DE 10 2004 021 532 describes a dispersion which, in addition to water, comprises 0.5 to 20% by weight of hydrophobic silica, 0.01 to 10% by weight of a gelling or viscosity-increasing additive, 0.1 to 1% by weight of a preservative and 0 to 1% by weight of a surface-active substance.

This dispersion can be used as insecticide against mites and other insects.

It is successfully used in spacious animal houses and on large surfaces, it being possible to use appropriately large-caliber sprayers (such as garden sprayers) for the spraying.

When used in the field of pets, where the area to be treated is rather small, large-caliber sprayers, such as, for example, garden sprayers, cannot be used.

In addition, pump spray bottles are not suitable because the necessary spraying pressure of more than 3 bar usually cannot be achieved. Accordingly, a good spray mist cannot be achieved and accordingly also a uniform covering of the cage area to be sprayed/treated cannot be achieved.

It is known to spray a pet cage area with a dispersion sold under the name “Decimite Aerosol”.

This dispersion consists of an aqueous dispersion of a few percent of hydrophilic silica. This dispersion has the disadvantage that it takes too long to dry. Furthermore, it has an excessively high viscosity and also excessively poor spray formation.

Furthermore, because of the water content of the dispersion, the spray can has to be lacquered on the inside.

The object was accordingly to prepare a dispersion with an insecticidal action which can be satisfactorily sprayed on small surfaces and also can quickly develop its action.

A subject-matter of the invention is a dispersion comprising hydrophobic pyrogenically prepared silicon dioxide, alcohol and at least one additive which promotes the dispersing.

Use may be made, as hydrophobic pyrogenically prepared silicon dioxide, of: Aerosil® R805, Aerosil® R974, Aerosil® R202, Aerosil® R812, Aerosil® R812S and Aerosil® R8200.

Use may in particular be made of Aerosil® R812S.

The physicochemical characteristics of these pyrogenically prepared silicon dioxides are listed in Table 1.

TABLE 1

| | | Test method | | | | | |
|---|---|---|---|---|---|---|---|
| | | Aerosil ® | Aerosil ® | Aerosil ® | Aerosil ® | Aerosil ® | Aerosil ® |
| | | R974 | R202 | R805 | R812 | R812S | R8200 |
| Behaviour with regard to water | | hydrophobic | | | | | |
| Appearance | | loose white powder | | | | | |
| BET surface ¹⁾ | m²/g | 170 ± 20 | 100 ± 20 | 150 ± 25 | 260 ± 30 | 220 ± 25 | 160 ± 25 |
| Mean size of the | nm | 12 | 14 | 12 | 7 | 7 | |
| primary particles | | | | | | | |
| Tamped density ²⁾ approximate value | | | | | | | |
| Normal product | g/l | 50 | 50 | 50 | 50 | 50 | 140 |
| Compacted product | g/l | 90 | | | | | |
| (additive “V”) | | | | | | | |
| Loss on drying ³⁾ | % by weight | ≦0.5 | ≦0.5 | ≦0.5 | ≦0.5 | ≦0.5 | ≦0.5 |
| (2 hours at 105° C.) | | | | | | | |
| on leaving the supplier | | | | | | | |
| Loss on ignition ^{4) 7)} | % by weight | ≦2 | 4-6 | 5-7 | 1.0-2.5 | 1.5-3.0 | |
| (2 hours at 1000° C.) | | | | | | | |
| C content | % by weight | 0.7-1.3 | 3.5-5.0 | 4.5-6.5 | 2.0-3.0 | 3.0-4.0 | 2.0-4.0 |
| pH ^{5) 10)} | | 3.7-4.7 | 4-6 | 3.5-5.5 | 5.5-7.5 | 5.5-7.5 | ≧5.0 |
| SiO₂ ⁸⁾ | % by weight | ≧99.8 | ≧99.8 | ≧99.8 | ≧99.8 | ≧99.8 | ≧99.8 |
| Al₃O₃ ⁸⁾ | % by weight | ≦0.05 | ≦0.05 | ≦0.05 | ≦0.05 | ≦0.05 | ≦0.05 |
| Fe₂O₃ ⁸⁾ | % by weight | ≦0.01 | ≦0.01 | ≦0.01 | ≦0.01 | ≦0.01 | ≦0.01 |
| TiO₂ ⁸⁾ | % by weight | ≦0.03 | ≦0.03 | ≦0.03 | ≦0.03 | ≦0.03 | ≦0.03 |
| HCl ¹¹⁾ | % by weight | ≦0.1 | ≦0.025 | ≦0.025 | ≦0.025 | ≦0.025 | ≦0.025 |

¹⁾ following DIN 66131
²⁾ following DIN ISO 787/11, JIS K 5101/18 (not sieved)
³⁾ following DIN ISO 787/2, ASTM D 280, JIS K 5101/21
⁴⁾ following DIN 55921, ASTM D 1208, JIS K 5101/23
⁵⁾ following DIN ISO 787/9, ASTM D 1208, JIS K 5101/24
⁷⁾ based on the substance dried at 105° C. for 2 hours
⁸⁾ based on the substance ignited at 1000° C. for 2 hours
¹⁰⁾ in water:methanol = 1:1
¹¹⁾ HCl content is constituent of the loss on ignition
¹²⁾ V product is supplied in bags of 15 kg net

The following can be used as alcohol: methanol, ethanol, propanol, isopropanol, 1-butanol, 2-methyl-1-propanol, 2-butanol and 2-methyl-2-propanol.

Use may in particular be made of low-boiling-point alcohols, such as, for example, ethanol.

In order to make possible good dispersing, it is, however, necessary to add an additive which promotes the dispersion, which additive covers remaining areas or new areas, not surface-modified, produced by the dispersing. The addition of hexamethyldisilazane (HMDS) has proven to be very advantageous for this.

The HMDS results, by this additional silanization, in a virtually perfect surface modification, through which a considerably lower viscosity is achieved. If appropriate, any excess HMDS can be converted by alcoholysis to give trimethylethoxysilane, trimethylsilanol or hexamethyldisiloxane, and NH₃.

Use may furthermore be made, as additive which promotes the dispersion, of other silanes which are likewise in a position to react with Si—OH groups still present on the Aerosil surface.

In principle, any silane is suitable which exhibits a satisfactory hydrophobic group but which in this connection does not introduce, through the silanization, any accessible additional silanol group. This can be achieved by having present only one group in the silane molecule capable of reacting with the SiOH group of the surface, thus an ROH or X group. Alternatively, the hydrophobic “residue” of the silane molecule can have such a strong sterically shielding effect that an unreacted SiOH group of the silane molecule is not accessible.

Furthermore, the silane used should exhibit a high reaction rate. A satisfactory reaction rate may possibly be achieved by an increase in temperature.

Silazanes, and here in particular hexamethyldisilazane, have, due to the basic nature of the silazane group, a high affinity for SiOH surface groups. Only in the subsequent step is the trimethylsilyl group transferred. Trimethylsilyl groups not reacted with SiOH surface groups are themselves inactivated by dimerization.

The following silanes can be used as additional silanes:
a) organosilanes of the (RO)₃Si(CₙH₂ₙ₊₁) and (RO)₃Si(CₙH₂ₙ₋₁) type
   R=alkyl, such as, for example, methyl, ethyl, n-propyl, isopropyl or butyl,
   n=1-20
b) organosilanes of the R′ₓ(RO)_{y}Si(CₙH₂ₙ₊₁) and R′ₓ(RO)_{y}Si(CₙH₂ₙ₋₁) type
   R=alkyl, such as, for example, methyl, ethyl, n-propyl, isopropyl or butyl
   R′=alkyl, such as, for example, methyl, ethyl, n-propyl, isopropyl or butyl
   R′=cycloalkyl
   n=1-20
   x+y=3
   x=1,2
   y=1,2
c) haloorganosilanes of the X₃Si(CₙH₂ₙ₊₁) and X₃Si(CₙH₂ₙ₋₁) type
   X═Cl, Br
   n=1-20
d) haloorganosilanes of the X₂(R′)Si(CₙH₂ₙ₊₁) and X₂(R′)Si(CₙH₂ₙ₋₁) type
   X═Cl, Br
   R′=alkyl, such as, for example, methyl, ethyl, n-propyl, isopropyl or butyl
   R′=cycloalkyl
   n=1-20
e) haloorganosilanes of the X(R′)₂Si(CₙH₂ₙ₊₁) and X(R′)₂Si(CₙH₂ₙ₋₁) type
   X═Cl, Br
   R′=alkyl, such as, for example, methyl, ethyl, n-propyl, isopropyl or butyl
   R′=cycloalkyl
   n=1-20
f) organosilanes of the (RO)₃Si(CH₂)ₘ—R′ type
   R=alkyl, such as methyl, ethyl or propyl
   m=0, 1-20
   R′=methyl, aryl (for example —C₆H₅, substituted phenyl radicals)
      —C₄F₉, OCF₂—CHF—CF₃, —C₆F₁₃, —O—CF₂—CHF₂ —CH═CH₂,
g) organosilanes of the (R″)ₓ(RO)_{y}Si(CH₂)ₘ—R′ type
   R″=alkyl x+y=3
      =cycloalkyl x=1,2
         y=1,2
         m=0,1 to 20
   R′=methyl, aryl (for example —C₆H₅, substituted phenyl radicals)
      —C₄F₉, —OCF₂—CHF—CF₃, —C₆F₁₃, —O—CF₂—CHF₂ —CH═CH₂,
h) haloorganosilanes of the X₃Si(CH₂)ₘ—R′ type
   X═Cl, Br
   m=0,1-20
   R′=methyl, aryl (for example —C₆H₅, substituted phenyl radicals)
      —C₄F₉, —OCF₂—CHF—CF₃, —C₆F₁₃, —O—CF₂—CHF₂ —CH═CH₂,
i) haloorganosilanes of the (R)X₂Si(CH₂)ₘ—R′ type
   X═Cl, Br
   R=alkyl, such as methyl, ethyl or propyl
   m=0,1-20
   R′=methyl, aryl (e.g. —C₆H₅, substituted phenyl radicals)
      —C₄F₉, —OCF₂—CHF—CF₃, —C₆F₁₃, —O—CF₂—CHF₂ —CH═CH₂
j) haloorganosilanes of the (R)₂XSi(CH₂)ₘ—R′ type
   X═Cl, Br
   R=alkyl
   m=0,1-20
   R′=methyl, aryl (e.g. —C₆H₅, substituted phenyl radicals)
      —C₄F₉, —OCF₂—CHF—CF₃, —C₆F₁₃, —O—CF₂—CHF₂ —CH═CH₂,
k) silazanes of the

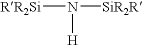

type
R=alkyl, aryl
R′=alkyl, aryl
l) cyclic polysiloxanes of the D3, D4 and D5 type, D3, D4 and D5 being understood as meaning cyclic polysiloxanes with 3, 4 or 5 units of the —O—Si(CH₃)₂— type. E.g. octamethylcyclotetrasiloxane=D4

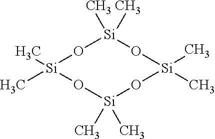

(m) polysiloxanes or silicone oils of the type

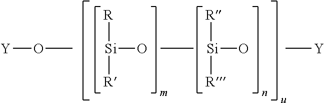

m=0, 1, 2, 3, . . . ∞
n=0, 1, 2, 3, . . . ∞
u=0, 1, 2, 3, . . . ∞

Y═CH₃, H, CₙH₂ₙ₊₁ n=1-20

Y═Si(CH₃)₃, Si(CH₃)₂H Si(CH₃)₂OH, Si(CH₃)₂(OCH₃) Si(CH₃)₂(CₙH₂ₙ₊₁) n=1-20
R=alkyl, such as CₙH₂ₙ₊₁, in which n=1 to 20, aryl, such as phenyl and substituted phenyl radicals, H
R′=alkyl, such as CₙH₂ₙ₊₁, in which n=1 to 20, aryl, such as phenyl and substituted phenyl radicals, H,
R″=alkyl, such as CₙH₂ₙ₊₁, in which n=1 to 20, aryl, such as phenyl and substituted phenyl radicals, H
R′″=alkyl, such as CₙH₂ₙ₊₁, in which n=1 to 20, aryl, such as phenyl and substituted phenyl radicals, H

Hydrophobic pyrogenically prepared silicon dioxides can be very well dispersed in alcohols since these are wetted with alcohols.

Furthermore, rapid drying of the sprayed surfaces/cage areas is achieved by the use of in particular highly volatile alcohols, such as ethanol or isopropanol. The lethal action also starts more quickly through this.

Rheology-modifying additives can be added for satisfactory adhesion of the Aerosil to the surfaces/cage areas to be covered and in order to prevent the sprayed-on dispersion from flowing off. Such additives can be alcohol-soluble modified celluloses.

Hydroxypropylcellulose (HPC) can in particular be used for this since it is satisfactorily soluble in alcohols.

The hydroxypropylcellulose can exhibit a molecular weight of less than 1 000 000.

In a preferred embodiment of the invention, the hydroxypropylcellulose can exhibit a molecular weight of 5000 to 500 000, in particular 80 000±20 000.

It can be seen from the examples that the amounts of the rheology-modifying agent used also affects the activity of the dispersion. This amount used can be limited by the product of the average molecular weight of the hydroxypropylcellulose and the concentration in % by weight. It can be less than 250 000.

HPC with an excessively high molecular weight of more than 1 000 000 results in a high structural viscosity which not only leads to a poor ability to be sprayed but also contributes to a reduction in the mortality.

With the dispersion according to the invention, it is possible, by the use of alcohol, to dispense with an addition of additives for the preservation of the hydroxypropylcellulose employed.

In a particularly preferred embodiment of the invention, the dispersion according to the invention can be composed of hydrophobic pyrogenically prepared silicon dioxide, alcohol and an additive which promotes the dispersion. If appropriate, the preferred dispersion can additionally comprise a rheology-modifying additive.

The dispersion according to the invention can be used as insecticide, in particular for combating mites.

On using at a high relative humidity, the activity declines, however, because, for example, the mites then cannot be satisfactorily desiccated.

The known chemically active pesticides, such as insecticides and in particular acaricides (pesticides for combating mites and ticks), are certainly highly active, even at high air humidities; unfortunately, relatively high residues of the pesticides can also be observed however, e.g. in uses in henhouses against the poultry red mite in the chicken and chicken eggs. With smaller birds in particular, the high concentration of pesticide necessarily used can also result directly in intolerance.

An essential protective function of the surface of the insects, for example of the mites, is weakened, if not removed, by the defatting or dewaxing action of the hydrophobic silica, so that, in the following stage, organic pesticide active substances can more easily and more quickly penetrate into the insect, in order to develop their action even at high air humidities. Since the protecting fatty or waxy layer has now been removed, the damaging or lethal action of the organic pesticide active substances can already be achieved with considerably lower concentrations.

The use of the active substance combination according to the invention with markedly reduced organic pesticide concentration also results in a considerable reduction in the residue formation, e.g. with uses in henhouses against the poultry red mite in the chicken and in the egg.

Since the active substance combination according to the invention comprises an active pesticide component with a damaging or lethal effect, it is also possible to combat harmful organisms which are resistant to desiccation, be it through a considerably denser surface than with mites or through the sheer size of the harmful organism, in which the surface to volume ratio is markedly smaller in comparison with the relatively small mites. Desiccation accordingly cannot be achieved or cannot be quickly achieved.

The following active substance groups can in particular be used as insecticides or acaricides, some exhibiting both insecticidal and acaricidal properties.

Organic Insecticides
botanical insecticides
anabasine
azadirachtin
d-limonene
nicotine
pyrethrins
   cinerins
      cinerin I
      cinerin II
   jasmolin I
   jasmolin II
   pyrethrin I
   pyrethrin II
rotenone
ryania
sabadilla
carbamate insecticides
bendiocarb
carbaryl
   benzofuranyl methylcarbamate insecticides
   benfuracarb
   carbofuran
   carbosulfan
   decarbofuran
   furathiocarb
   dimethylcarbamate insecticides
   dimetan
   dimetilan
   hyquincarb
   pirimicarb
   oxime carbamate insecticides
   alanycarb
   aldicarb
   aldoxycarb
   butocarboxim
   butoxycarboxim
   methomyl
   nitrilacarb
   oxamyl
   tazimcarb
   thiocarboxime
   thiodicarb
   thiofanox
   phenyl methylcarbamate insecticides
   allyxycarb
   aminocarb
   bufencarb
   butacarb
   carbanolate
   cloethocarb
   dicresyl
   dioxacarb
   EMPC
   ethiofencarb
   fenethacarb
   fenobucarb
   isoprocarb
   methiocarb
   metolcarb
   mexacarbate
   promacyl
   promecarb
   propoxur
   trimethacarb
   XMC
   xylylcarb
diamide insecticides
chlorantraniliprole
flubendiamide
dinitrophenol insecticides
dinex
dinoprop
dinosam
DNOC
fluorine insecticides
sulfluramid
formamidine insecticides
amitraz
chlordimeform
formetanate
formparanate
insect growth regulators
   chitin synthesis inhibitors
   bistrifluron
   buprofezin
   chlorfluazuron
   cyromazine
   diflubenzuron
   flucycloxuron
   flufenoxuron
   hexaflumuron
   lufenuron
   novaluron
   noviflumuron
   penfluron
   teflubenzuron
   triflumuron
   juvenile hormone mimics
   epofenonane
   fenoxycarb
   hydroprene
   kinoprene
   methoprene
   pyriproxyfen
   triprene
   juvenile hormones
   juvenile hormone I
   juvenile hormone II
   juvenile hormone III
   moulting hormone agonists
   chromafenozide
   halofenozide
   methoxyfenozide
   tebufenozide
   moulting hormones
   α-ecdysone
   ecdysterone
   moulting inhibitors
   diofenolan
   precocenes
   precocene I
   precocene II
   precocene III
   unclassified insect growth regulators
   dicyclanil
nereistoxin analogue insecticides
bensultap
cartap
thiocyclam
thiosultap
nicotinoid insecticides
flonicamid
   nitroguanidine insecticides
   clothianidin
   dinotefuran
   imidacloprid
   thiamethoxam
   nitromethylene insecticides
   nitenpyram
   nithiazine
   pyridylmethylamine insecticides
   acetamiprid
   imidacloprid
   nitenpyram
   thiacloprid
organochlorine insecticides
bromo-DDT
camphechlor
DDT
   pp′-DDT
ethyl-DDD
HCH
   gamma-HCH
   lindane
methoxychlor
pentachlorophenol
TDE
   cyclodiene insecticides
   aldrin
   bromocyclen
   chlorbicyclen
   chlordan
   chlordecone
   dieldrin
   dilor
   endosulfan
   endrin
   HEOD
   heptachlor
   HHDN
   isobenzan
   isodrin
   kelevan
   mirex
organophosphorus insecticides
   organophosphate insecticides
   bromfenvinfos
   chlorfenvinphos
   crotoxyphos
   dichlorvos
   dicrotophos
   dimethylvinphos
   fospirate
   heptenophos
   methocrotophos
   mevinphos
   monocrotophos
   naled
   naftalofos
   phosphamidon
   propaphos
   TEPP
   tetrachlorvinphos
   organothiophosphate insecticides
   dioxabenzofos
   fosmethilan
   phenthoate
      aliphatic organothiophosphate insecticides
      acethion
      amiton
      cadusafos
      chlorethoxyfos
      chlormephos
      demephion
         demephion-O
         demephion-S
      demeton
         demeton-O
         demeton-S
      demeton-methyl
         demeton-O-methyl
         demeton-S-methyl
      demeton-S-methylsulphon
      disulfoton
      ethion
      ethoprophos
      IPSP
      isothioate
      malathion
      methacrifos
      oxydemeton-methyl
      oxydeprofos
      oxydisulfoton
      phorate
      sulfotep
      terbufos
      thiometon
         aliphatic amide organothiophosphate insecticides
         amidithion
         cyanthoate
         dimethoate
         ethoate-methyl
         formothion
         mecarbam
         omethoate
         prothoate
         sophamide
         vamidothion
         oxime organothiophosphate insecticides
         chlorphoxim
         phoxim
         phoxim-methyl
      heterocyclic organothiophosphate insecticides
      azamethiphos
      coumaphos
      coumithoate
      dioxathion
      endothion
      menazon
      morphothion
      phosalone
      pyraclofos
      pyridaphenthion
      quinothion
         benzothiopyran organothiophosphate insecticides
         dithicrofos
         thicrofos
         benzotriazine organothiophosphate insecticides
         azinphos-ethyl
         azinphos-methyl
         isoindole organothiophosphate insecticides
         dialifos
         phosmet
         isoxazole organothiophosphate insecticides
         isoxathion
         zolaprofos
         pyrazolopyrimidine organothiophosphate insecticides
         chlorprazophos
         pyrazophos
         pyridine organothiophosphate insecticides
         chlorpyrifos
         chlorpyrifos-methyl
         pyrimidine organothiophosphate insecticides
         butathiofos
         diazinon
         etrimfos
         lirimfos
         pirimiphos-ethyl
         pirimiphos-methyl
         primidophos
         pyrimitate
         tebupirimfos
         quinoxaline organothiophosphate insecticides
         quinalphos
         quinalphos-methyl
         thiadiazole organothiophosphate insecticides
         athidathion
         lythidathion
         methidathion
         prothidathion
         triazole organothiophosphate insecticides
         isazofos
         triazophos
      phenyl organothiophosphate insecticides
      azothoate
      bromophos
      bromophos-ethyl
      carbophenothion
      chlorthiophos
      cyanophos
      cythioate
      dicapthon
      dichlofenthion
      etaphos
      famphur
      fenchlorphos
      fenitrothion
      fensulfothion
      fenthion
      fenthion-ethyl
      heterophos
      jodfenphos
      mesulfenfos
      parathion
      parathion-methyl
      phenkapton
      phosnichlor
      profenofos
      prothiofos
      sulprofos
      temephos
      trichlormetaphos-3
      trifenofos
   phosphonate insecticides
   butonate
   trichlorfon
   phosphonothioate insecticides
   mecarphon
      phenyl ethylphosphonothioate insecticides
      fonofos
      trichloronat
      phenyl phenylphosphonothioate insecticides
      cyanofenphos
      EPN
      leptophos
   phosphoramidate insecticides
   crufomate
   fenamiphos
   fosthietan
   mephosfolan
   phosfolan
   pirimetaphos
   phosphoramidothioate insecticides
   acephate
   isocarbophos
   isofenphos
   methamidophos
   propetamphos
   phosphorodiamide insecticides
   dimefox
   mazidox
   mipafox
   schradan
oxadiazine insecticides
indoxacarb
oxadiazolone insecticides
metoxadiazone
phthalimide insecticides
dialifos
phosmet
tetramethrin
pyrazole insecticides
chlorantraniliprole
dimetilan
tebufenpyrad
tolfenpyrad
   phenylpyrazole insecticides
   acetoprole
   ethiprole
   fipronil
   pyraclofos
   pyrafluprole
   pyriprole
   vaniliprole
pyrethroid insecticides
   pyrethroid ester insecticides
   acrinathrin
   allethrin
      bioallethrin
   barthrin
   bifenthrin
   bioethanomethrin
   cyclethrin
   cycloprothrin
   cyfluthrin
      beta-cyfluthrin
   cyhalothrin
      gamma-cyhalothrin
      lambda-cyhalothrin
   cypermethrin
      alpha-cypermethrin
      beta-cypermethrin
      theta-cypermethrin
      zeta-cypermethrin
   cyphenothrin
   deltamethrin
   dimefluthrin
   dimethrin
   empenthrin
   fenfluthrin
   fenpirithrin
   fenpropathrin
   fenvalerate
      esfenvalerate
   flucythrinate
   fluvalinate
      tau-fluvalinate
   furethrin
   imiprothrin
   metofluthrin
   permethrin
      biopermethrin
      transpermethrin
   phenothrin
   prallethrin
   profluthrin
   pyresmethrin
   resmethrin
      bioresmethrin
      cismethrin
   tefluthrin
   terallethrin
   tetramethrin
   tralomethrin
   transfluthrin
   pyrethroid ether insecticides
   etofenprox
   flufenprox
   halfenprox
   protrifenbute
   silafluofen
pyrimidinamine insecticides
flufenerim
pyrimidifen
Pyrrole insecticides
chlorfenapyr
tetramic acid insecticides
spirotetramat
tetronic acid insecticides
spiromesifen
thiazole insecticides
clothianidin
thiamethoxam
thiazolidine insecticides
tazimcarb
thiacloprid
thiourea insecticides
diafenthiuron
urea insecticides
flucofuron
sulcofuron
see also chitin synthesis inhibitors
antibiotic insecticides
allosamidin
thuringiensin
   macrocyclic lactone insecticides
      avermectin insecticides
      abamectin
      doramectin
      emamectin
      eprinomectin
      selamectin
      milbemycin insecticides
      lepimectin
      milbemectin
      milbemycin oxime
      moxidectin
      spinosyn insecticides
      spinetoram
      spinosad
unclassified insecticides
closantel
copper naphthenate
crotamiton
EXD
fenazaflor
fenoxacrim
hydramethylnon
isoprothiolane
malonoben
metaflumizone
nifluridide
pyridaben
pyridalyl
pyrifluquinazon
rafoxanide
triarathene
triazamate

Organic Acaricides
bridged diphenyl acaricides
azobenzene
benzoximate
benzyl benzoate
bromopropylate
chlorbenside
chlorfenethol
chlorfenson
chlorfensulphide
chlorobenzilate
chloropropylate
cyflumetofen
DDT
dicofol
diphenyl sulfone
dofenapyn
fenson
fentrifanil
fluorbenside
proclonol
tetradifon
tetrasul
carbamate acaricides
benomyl
carbanolate
carbaryl
carbofuran
methiocarb
metolcarb
promacyl
propoxur
   oxime carbamate acaricides
   aldicarb
   butocarboxim
   oxamyl
   thiocarboxime
   thiofanox
coarbazate acaricides
bifenazate
dinitrophenol acaricides
binapacryl
dinex
dinobuton
dinocap
   dinocap-4
   dinocap-6
dinocton
dinopenton
dinosulfon
dinoterbon
DNOC
formamidine acaricides
amitraz
chlordimeform
chloromebuform
formetanate
formparanate
mite growth regulators
clofentezine
cyromazine
diflovidazin
dofenapyn
fluazuron
flubenzimine
flucycloxuron
flufenoxuron
hexythiazox
organochlorine acaricides
bromocyclen
camphechlor
DDT
dienochlor
endosulfan
lindane
organophosphorus acaricides
   organophosphate acaricides
   chlorfenvinphos
   crotoxyphos
   dichlorvos
   heptenophos
   mevinphos
   monocrotophos
   naled
   TEPP
   tetrachlorvinphos
   organothiophosphate acaricides
   amidithion
   amiton
   azinphos-ethyl
   azinphos-methyl
   azothoate
   benoxafos
   bromophos
   bromophos-ethyl
   carbophenothion
   chlorpyrifos
   chlorthiophos
   coumaphos
   cyanthoate
   demeton
      demeton-O
      demeton-S
   demeton-methyl
      demeton-O-methyl
      demeton-S-methyl
   demeton-S-methylsulphon
   dialifos
   diazinon
   dimethoate
   dioxathion
   disulfoton
   endothion
   ethion
   ethoate-methyl
   formothion
   malathion
   mecarbam
   methacrifos
   omethoate
   oxydeprofos
   oxydisulfoton
   parathion
   phenkapton
   phorate
   phosalone
   phosmet
   phoxim
   pirimiphos-methyl
   prothidathion
   prothoate
   pyrimitate
   quinalphos
   quintiofos
   sophamide
   sulfotep
   thiometon
   triazophos
   trifenofos
   vamidothion
   phosphonate acaricides
   trichlorfon
   phosphoramidothioate acaricides
   isocarbophos
   methamidophos
   propetamphos
   phosphorodiamide acaricides
   dimefox
   mipafox
   schradan
organotin acaricides
azocyclotin
cyhexatin
fenbutatin oxide
phenylsulphamide acaricides
dichlofluanid
phthalimide acaricides
dialifos
phosmet
pyrazole acaricides
cyenopyrafen
fenpyroximate
tebufenpyrad
   phenylpyrazole acaricides
   acetoprole
   fipronil
   vaniliprole
pyrethroid acaricides
   pyrethroid ester acaricides
   acrinathrin
   bifenthrin
   cyhalothrin
   cypermethrin
      alpha-cypermethrin
   fenpropathrin
   fenvalerate
   flucythrinate
   flumethrin
   fluvalinate
      tau-fluvalinate
   permethrin
   pyrethroid ether acaricides
   halfenprox
pyrimidinamine acaricides
pyrimidifen
pyrrole acaricides
chlorfenapyr
quinoxaline acaricides
chinomethionat
thioquinox
sulphite ester acaricides
propargite
tetronic acid acaricides
spirodiclofen
tetrazine acaricides
clofentezine
diflovidazin
thiazolidine acaricides
flubenzimine
hexythiazox
thiocarbamate acaricides
fenothiocarb
thiourea acaricides
chloromethiuron
diafenthiuron
antibiotic acaricides
nikkomycins
thuringiensin
   macrocyclic lactone acaricides
   tetranactin
      avermectin acaricides
      abamectin
      doramectin
      eprinomectin
      ivermectin
      selamectin
      milbemycin acaricides
      milbemectin
      milbemycin oxime
      moxidectin
unclassified acaricides
acequinocyl
amidoflumet
arsenous oxide
closantel
crotamiton
disulfiram
etoxazole
fenazaflor
fenazaquin
fluacrypyrim
fluenetil
mesulfen
MNAF
nifluridide
pyridaben
sulfiram
sulfluramid
sulfur
triarathene

The dispersions according to the invention can be satisfactorily sprayed with propellent gas sprays.

An additional advantage of the alcoholic dispersion according to the invention is caused by the fact that the alcohol does not have a corrosive effect on the metals used in spray cans. Internal lacquering of the cans can accordingly be dispensed with.

An additional subject-matter of the invention is a spray can which comprises the dispersion according to the invention.

This spray can additionally comprise a propellent.

Use may be made, as propellent, of propane, butane or a mixture of propane and butane with a proportion of propellent gas of 10 to 80%.

Nitrogen or nitrous oxide can be used as propellent gas.

The pressure necessary for the spraying can be produced by a pump system.

1. Dispersion comprising hydrophobic pyrogenically prepared silicon dioxide, alcohol and at least one additive which promotes the dispersion and, as additional component, at least one insecticide and/or acaricide.

2. Dispersion according to claim 1, characterized in that it comprises a rheology-promoting agent.

3. Dispersion according to claim 2, characterized in that hydroxypropylcellulose is used as rheology-promoting agent.

4. Use of the dispersion according to claim 1 as acaricide and insecticide.

5. Spray can comprising the dispersion according to claim 1.

6. Spray can according to claim 5, additionally comprising a propellent.

7. Spray can according to claim 6, characterized in that propellents, such as propane, butane or a mixture of propane and butane, are used with a proportion of propellent gas of 10-80%.

8. Spray can according to claim 6, characterized in that nitrogen is used as propellent gas.

9. Spray can according to claim 6, characterized in that nitrous oxide is used as propellent gas.

10. Spray can according to claim 5, characterized in that the pressure necessary for the spraying is produced by a pump system.
